(19) United States
(12) Patent Application Publication
(10) Pub. No.: US 2026/0119352 A1
(43) Pub. Date: Apr. 30, 2026

(54) ELECTRONIC DEVICE TESTING METHOD AND ELECTRONIC DEVICE TESTING SYSTEM

(71) Applicant: ASUS GLOBAL PTE. LTD., Singapore (SG)

(72) Inventor: Bin Chen, SINGAPORE (SG)

(73) Assignee: ASUS GLOBAL PTE. LTD., Singapore (SG)

(21) Appl. No.: 19/330,847

(22) Filed: Sep. 17, 2025

(30) Foreign Application Priority Data
Oct. 25, 2024 (TW) 113140789

(51) Int. Cl. G06F 11/26; G06F 3/041

(52) U.S. Cl. CPC G06F 11/26; G06F 3/0418

(57) ABSTRACT

An electronic device testing method and an electronic device testing system are provided. The method includes following steps. A display image displayed by an electronic device under test is captured through a camera device. By analyzing the display image displayed by the electronic device under test, an automatic control command is determined. The automation control command is sent to the electronic device under test or an external execution device to control the electronic device under test to execute a target operation corresponding to the automation control command. While the electronic device under test performs the target operation, a device testing procedure of the electronic device under test is executed.

### CROSS-REFERENCE TO RELATED APPLICATION

This application claims the priority benefit of Taiwan application serial no. 113140789, filed on Oct. 25, 2024. The entirety of the above-mentioned patent application is hereby incorporated by reference herein and made a part of this specification.

### BACKGROUND

### Technical Field

The disclosure relates to an electronic device testing method and an electronic device testing system.

### Description of Related Art

The use of electronic devices for gaming has become an increasingly popular leisure activity. However, playing games typically requires the electronic devices to operate in a high-performance state, which significantly increases power consumption of the electronic devices. Therefore, developers of the electronic devices conduct various performance tests while the electronic devices are running game applications to ensure stable operation of the electronic devices under high-performance conditions and to make necessary adjustments for performance optimization. The developers of the electronic devices can manually utilize the electronic devices to play games and perform various performance tests during the execution of game applications. However, this manual testing method is labor-intensive and inefficient. On the other hand, when conducting automated testing of the electronic devices, the devices are required to capture, analyze, and process the display screen independently to determine how to automatically control the game application subsequently. These operations require additional computational resources and power, which can compromise the accuracy of performance testing and lead to biased or imprecise test results.

### SUMMARY

The disclosure provides an electronic device testing method, and the method includes following steps. A display image displayed by an electronic device under test is captured through a camera device. An automated control command is determined by analyzing the display image displayed by the electronic device under test. The automated control command is sent to the electronic device under test or an external execution device to control the electronic device under test to execute a target operation corresponding to the automated control command. During the target operation executed by the electronic device under test, a device testing procedure of the electronic device under test is executed.

The disclosure also provides an electronic device testing system which includes an electronic device under test, a camera device, and a computer device. The camera device is configured to capture a display image displayed by the electronic device under test. The computer device is coupled to the camera device. The computer device determines an automated control command by analyzing the display image displayed by the electronic device under test. The computer device sends the automated control command to control the electronic device under test to execute a target operation corresponding to the automated control command. During the target operation executed by the electronic device under test, the electronic device under test executes a device testing procedure of the electronic device under test.

In view of above, in one or more embodiments of the disclosure, the camera device can provide the display image displayed by the electronic device to the computer device for analysis. The computer device can analyze the real-time display image to determine the automated control command. Through sending the automated control command, the computer device can control the electronic device under test to execute the target operation corresponding to the automated control command. The electronic device under test can execute the device testing procedure during the execution of the target operation. By utilizing computational resources of the computer device for visual analysis and issuance of a control command, the device testing procedure can be performed without occupying the computational resources of the electronic device under test. Accordingly, power consumption and performance data collected through the automated test can be more accurate, and the manpower requirements for device testing can be effectively reduced.

To make the above features and advantages of the disclosure more apparent and understandable, embodiments are described below with reference to the accompanying drawings for detailed explanation as follows.

### BRIEF DESCRIPTION OF THE DRAWINGS

FIG. 1A and FIG. 1B are schematic diagrams of an electronic device testing system according to an embodiment of the disclosure.

FIG. 2A is a block diagram of a computer device according to an embodiment of the disclosure.

FIG. 2B is a block diagram of an electronic device under test according to an embodiment of the disclosure.

FIG. 3 is a flowchart of an electronic device testing method according to an embodiment of the disclosure.

FIG. 4 is a schematic diagram of a display image according to an embodiment of the disclosure.

FIG. 5 is a flowchart of determining an automated control command according to an embodiment of the disclosure.

FIG. 6 is a schematic diagram of determining an automated control command according to an embodiment of the disclosure.

FIG. 7 is a schematic diagram of object recognition and determination of touch input according to an embodiment of the disclosure.

FIG. 8 is a schematic diagram of determining an automated control command according to an embodiment of the disclosure.

### DESCRIPTION OF THE EMBODIMENTS

Reference will now be made in detail to exemplary embodiments of the disclosure, examples of which are illustrated in the accompanying drawings. Wherever possible, the same reference numbers are used in the drawings and the description to refer to the same or like parts. These embodiments are a part of the disclosure and do not reveal all possible implementation manner provided in the disclosure. More precisely, these embodiments are examples of systems and methods within the protection scope provided in the disclosure.

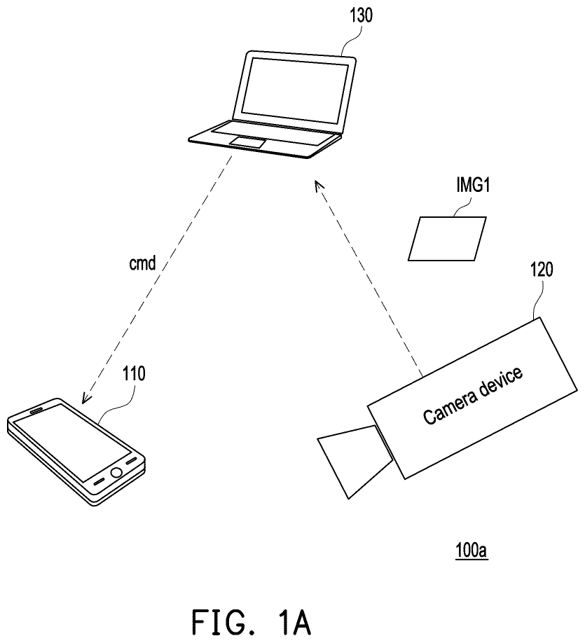

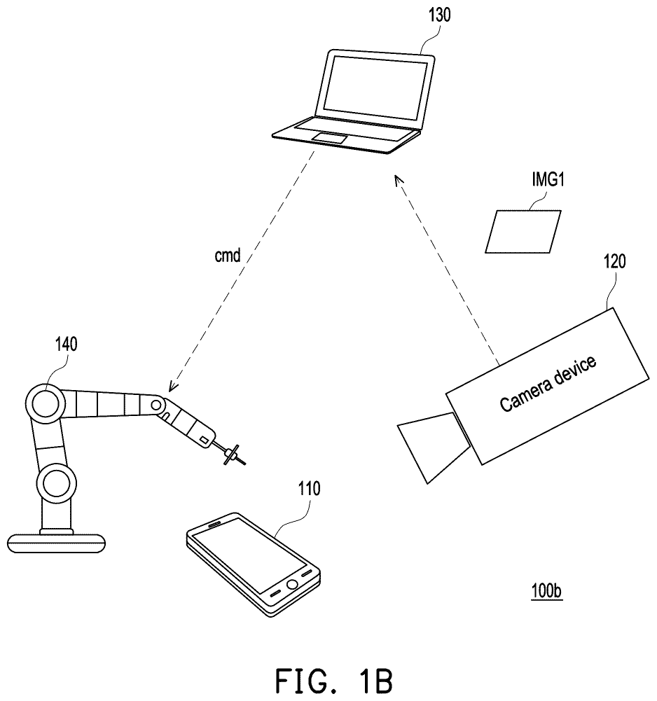

With reference to FIG. 1A, which is a schematic diagram of an electronic device testing system according to an embodiment of the disclosure, an electronic device testing system 100a includes an electronic device under test 110, a camera device 120, and a computer device 130.

The electronic device under test 110 can be, for instance, a smartphone, a tablet computer, a laptop computer, or any other electronic device with a touch input function and a display function, which should not be construed as a limitation in the disclosure. In some embodiments, the electronic device under test 110 can execute a device testing procedure during the execution of a game application to obtain a test result of the electronic device under test 110.

The camera device 120 is coupled to the computer device 130 and is configured to capture images to generate a video stream, and the camera device 120 includes a camera lens with a lens and a photosensitive element. The photosensitive element is configured to sense the intensity of light entering the lens, thereby generating images. The photosensitive element can be, for instance, a charge coupled device (CCD), a complementary metal-oxide semiconductor (CMOS) element, or any other element, which should not be construed as a limitation in the disclosure.

In some embodiments, the camera device 120 is arranged at a fixed position and can continuously capture the display images displayed by the electronic device under test 110 to generate a video stream. The camera device 120 provides the video stream to the computer device 130. The video stream can include a plurality of frames corresponding to different time points, such as a display image IMG1. In other words, the display images displayed by the electronic device under test 110 and captured by the camera device 120 can be continuously sent to the computer device 130.

In some embodiments, when the electronic device under test 110 executes an application (e.g., a game application), the display image displayed by the electronic device under test 110 is a program screen of the application. That is, the camera device 120 can provide a series of game screens displayed by the electronic device under test 110 to the computer device 130.

In some embodiments, the camera device 120 sends the captured images to the computer device 130 through cable transmission or wireless transmission. For instance, the camera device 120 can send the captured images to the computer device 130 via USB transmission. Alternatively, the camera device 120 sends the captured images to the computer device 130 via wireless network transmission. The wireless transmission can include, for instance, Wi-Fi transmission and so on, which should not be construed as a limitation in the disclosure.

The computer device 130 can be, for instance, a laptop computer, a desktop computer, a server, a workstation, or another device with computing capabilities, which should not be construed as a limitation in the disclosure. The computer device 130 is coupled to the camera device 120. In some embodiments, the computer device 130 receives the video stream from the camera device 120 and analyze the display image IMG1 displayed by the electronic device under test 110 to determine an automated control command cmd. In the embodiment depicted in FIG. 1A, the computer device 130 is coupled to the electronic device under test 110 and send the automated control command cmd to the electronic device under test 110 via wireless transmission, thus enabling the electronic device under test 110 to execute a target operation in response to the automated control command cmd. The automated control command cmd can be a virtual touch command. In other words, the computer device 130 can automatically control the electronic device under test 110 according to the display image IMG1 displayed by the electronic device under test 110.

Please refer to FIG. 1B, which is a schematic diagram of an electronic device testing system according to an embodiment of the disclosure. The electronic device testing system 100b includes the electronic device under test 110, the camera device 120, the computer device 130, and an external execution device 140. Functions of the electronic device under test 110, the camera device 120, and the computer device 130 can be referred to as those described with reference to FIG. 1A and are not repeatedly described hereinafter. Different from what is shown in FIG. 1A, the computer device 130 is coupled to the external execution device 140 and sends the automated control command cmd to the external execution device 140, thus enabling the external execution device 140 to apply a touch operation to the electronic device under test 110 in response to the automated control command cmd. The external execution device 140 can be, for instance, a robotic arm or another automated mechanical equipment. The external execution device 140 can simulate human finger movements to precisely perform operations such as clicking, swiping, or long-pressing on the touch screen of the electronic device under test 110.

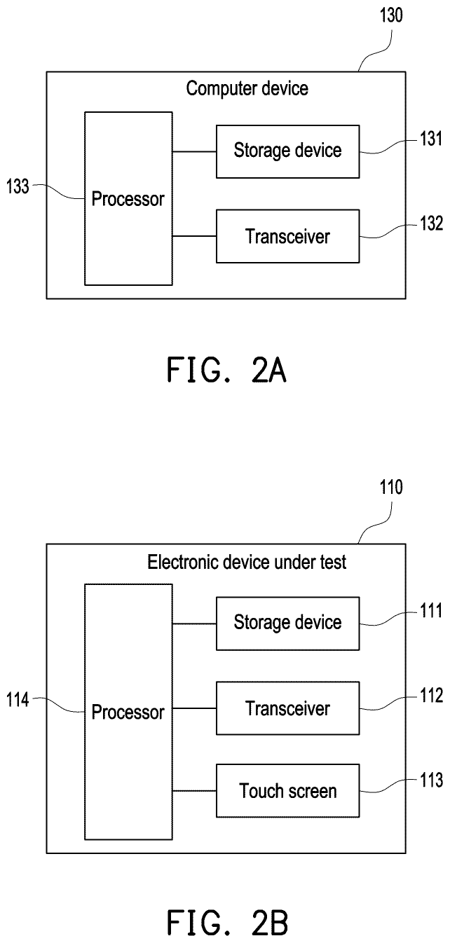

Please refer to FIG. 2A, which is a block diagram of a computer device according to an embodiment of the disclosure. The computer device 130 includes a storage device 131, a transceiver 132, and a processor 133. Please refer to FIG. 2B, which is a block diagram of an electronic device under test according to an embodiment of the disclosure. The electronic device under test 110 includes a storage device 111, a transceiver 112, a touch screen 113, and a processor 114.

The storage device 131 and the storage device 111 are configured to store data, such as files, images, commands, program codes, software modules, and so forth. The storage device 131 and the storage device 111 can be, for instance, any type of fixed or removable random access memories (RAM), read-only memories (ROM), flash memories, hard disks, other similar devices, integrated circuits, or combinations thereof.

The transceiver 132 and the transceiver 112 sends and receives signals through wireless transmission or through cables. The transceivers also perform operations such as low-noise amplification, impedance matching, frequency mixing, up or down frequency conversion, filtering, amplification, and similar operations. The computer device 130 receives and sends data through the transceiver 132, and the electronic device under test 110 receives and sends data through the transceiver 112. In some embodiments, the computer device 130 and the electronic device under test 110 further include antennas (not shown) for receiving wireless radio frequency signals.

In some embodiments, the touch screen 113 includes a display device and a touch device. The display device is configured to display images to users. The display device can be, for instance, a liquid crystal display (LCD), a light emitting diode (LED) display, a field emission display (FED), an organic light emitting diode (OLED) display, or another type of display, which should not be construed as a limitation in the disclosure.

The processor 114 and the processor 133 can be, for instance, a central processing unit (CPU), an application processor (AP), or another programmable general-purpose or special-purpose microprocessor, digital signal processors (DSP), programmable controller, application specific integrated circuit (ASIC), programmable logic device (PLD), graphics processing unit (GPU), or another similar device or combinations of these devices. The processor 114 and the processor 133 can respectively execute program codes, software modules, commands, and the like stored in the storage device 111 and the storage device 131 to implement the electronic device testing method provided in one or more embodiments of the disclosure. The software modules can be broadly interpreted to refer to commands, command sets, codes, program codes, programs, applications, software packages, threads, procedures, functions, and so on.

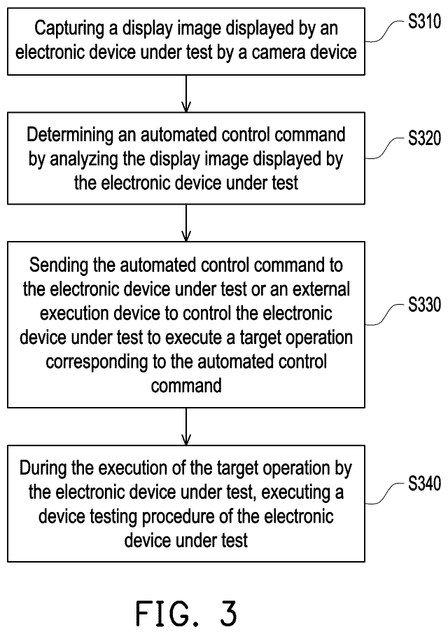

FIG. 3 is a flowchart of an electronic device testing method according to an embodiment of the disclosure. Please refer to FIG. 1A, FIG. 1B, and FIG. 3. The method provided in this embodiment is applicable to the electronic device testing system 100a or 100b described in the previous embodiments. Detailed steps of the electronic device testing method provided in this embodiment are explained with reference to the various elements in the electronic device testing system 100a or 100b.

In step S310, a display image IMG1 displayed by an electronic device under test 110 is captured by a camera device 120. The camera device 120 can be a dedicated camera device, a mobile phone, a computer with a camera, or the like. The camera device 120 is configured to substitute for human eyes to view the display screen of the electronic device under test 110. The camera device 120 can send the display image IMG1 displayed by the electronic device under test 110 to a computer device 130.

In step S320, the computer device 130 determines an automated control command cmd by analyzing the display image IMG1 displayed by the electronic device under test 110. The computer device 130 can analyze the display image IMG1 displayed by the electronic device under test 110 through a computer vision analysis procedure to determine how to control the electronic device under test 110 and generate the automated control command cmd.

In some embodiments, the computer device 130 can perform image comparison on the display image IMG1 to determine the corresponding touch input. In some embodiments, the computer device 130 can apply a trained convolutional neural network (CNN) model to analyze the display image IMG1 to determine the corresponding touch input. In some embodiments, the touch input can include touch positions or other touch parameters. The computer device 130 can generate the automated control command cmd according to the touch input. The image analysis and the generation of the automated control command cmd are explained in more detail in subsequent embodiments.

In the embodiment depicted in FIG. 1A, the automated control command cmd includes a virtual touch command sent to the electronic device under test 110. The virtual touch command is a digitalized command that simulates a real touch behavior. The virtual touch command can simulate finger touch operations on the touch screen of the electronic device under test 110. The electronic device under test 110 can execute test scripts according to the virtual touch command, simulate real user operations, and accordingly verify functions, performance, and stability of the electronic device under test 110. In some embodiments, the virtual touch command can be generated by specific software of the computer device 130, and a proxy application or system components on the electronic device under test 110 can be responsible for receiving and processing the virtual touch command. The electronic device under test 110 receives the command and converts the virtual touch command into equivalent touch operations.

In the embodiment depicted in FIG. 1B, the automated control command cmd includes an action control command sent to an external execution device 140, and the external execution device 140 performs a touch operation on the electronic device under test 110 according to the action control command. The touch operation performed by the external execution device 140 can include actions such as clicking, swiping, double-clicking, or long-pressing to simulate human interactions with the electronic device under test 110. The action control command serves to control a mechanical arm or another automated equipment to perform specific actions. The action control command can include parameters specifying the type, the location, the strength, the speed, and the duration of the action to simulate human touch operations.

In step S330, the computer device 130 sends the automated control command cmd to the electronic device under test 110 or the external execution device 140 to control the electronic device under test 110 to execute a target operation corresponding to the automated control command.

In some embodiments, when the computer device 130 sends the automated control command cmd to the electronic device under test 110, the electronic device under test 110 can execute the target operation corresponding to the virtual touch command. In some embodiments, the computer device 130 can establish a communication connection with the electronic device under test 110 through Wi-Fi android debug bridge (Wi-Fi adb) and then issue the automated control command cmd to the electronic device under test 110. The computer device 130 can use Wi-Fi adb to send touch events to the electronic device under test 110. The touch events supported by the Wi-Fi adb include, for instance, clicking events, swiping events, or long-pressing events, and so on.

In some embodiments, when the computer device 130 sends the automated control command cmd to the external execution device 140, the external execution device 140 can perform a touch operation on the electronic device under test 110 according to the action control command, thus enabling the electronic device under test 110 to react to the touch operation and execute the target operation. In some embodiments, the computer device 130 can issue the automated control command cmd to the external execution device 140 through cable transmission or wireless transmission.

In some embodiments, when the electronic device under test 110 executes a game application, the electronic device under test 110 displays a game screen of the game application. The display image IMG1 can include a game screen of a game application. In this case, the computer device 130 can control the game application of the electronic device under test 110 through the automated control command cmd. The game application of the electronic device under test 110 executes the target operation corresponding to the automated control command cmd. In some embodiments, the target operation includes behavior control of a virtual game character.

In other words, the computer device 130 can control the electronic device under test 110 to execute behavior control of the virtual game character through the automated control command cmd. Specifically, the computer device 130 can analyze the image IMG1 displayed by the electronic device under test 110, determine an appropriate control strategy based on results of the image analysis, and send the corresponding automated control command cmd to enable the electronic device under test 110 to operate the virtual game character to perform specific behaviors. As such, the computer device 130 can simulate the process of human beings operating the electronic device under test 110 to play the game, such as character movements, attacks, jumps, interactions, or other behaviors.

In step S340, during the execution of the target operation by the electronic device under test 110, the electronic device under test 110 executes a device testing procedure of the electronic device under test 110. In other words, when the electronic device under test 110 executes the target operation, the electronic device under test 110 can execute the device testing procedure to test software performance, hardware performance, or other device performance of the electronic device under test 110. For instance, during the process of controlling the electronic device under test 110 by the computer device 130 to automatically play the game, the electronic device under test 110 can execute the device testing procedure to learn various device performance characteristics of the electronic device under test 110 when executing the game application.

In some embodiments, during the execution of the target operation on the electronic device under test 110, the electronic device under test 110 executes the performance testing procedure of the electronic device under test 110. The performance testing procedure can be a processing performance test, a power consumption test, a heat dissipation test, an application launch speed test, a hardware aging test, or another software or hardware test. The electronic device under test 110 obtains a performance testing result of the performance testing procedure. In light of the foregoing, the computer device 130 can perform automated tests on the electronic device under test 110 without relying on the computing resources of the electronic device under test 110, thus effectively improving the efficiency and accuracy of the tests.

In some embodiments, the computer device 130 compares the display image with a plurality of default images. When the display image matches one of the default images, the computer device 130 obtains the automated control command cmd corresponding to one of the default images. The default images and the corresponding touch inputs can be recorded in advance. Specifically, each default image can correspond to a touch input. For instance, a first default image corresponds to a first touch input, while a second default image corresponds to a second touch input. These default images and the corresponding touch inputs establish automated control rules for controlling the electronic device under test 110. When the display image matches the first default image, the computer device 130 obtains the touch input corresponding to the first default image and converts the touch input corresponding to the first default image into the automated control command cmd.

In some embodiments, the computer device 130 determines whether the display image displayed by the electronic device under test 110 includes or is similar to one of the default images. When the display image includes or is similar to one of the default images, the computer device 130 can determine that the display image displayed by the electronic device under test 110 matches one of the default images.

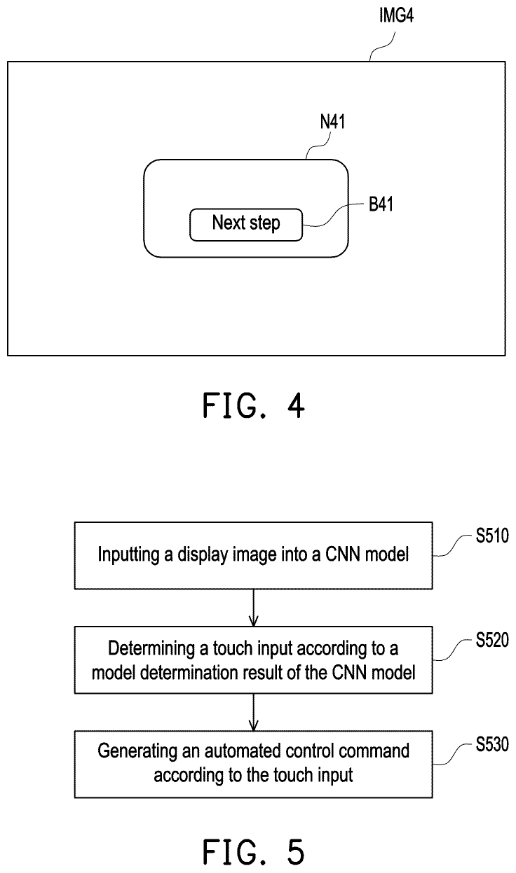

For instance, please refer to FIG. 4, which is a schematic diagram of a display image according to an embodiment of the disclosure. During the process of executing a game application by the electronic device under test 110, the camera device 120 can capture a display image IMG4 displayed by the electronic device under test 110, which is the game screen. The computer device 130 can perform image comparison between the display image IMG4 displayed by the electronic device under test 110 and the default images. The computer device 130 can determine that the display image IMG4 includes a default dialog box N41 (i.e., one of the default images). Hence, the computer device 130 can obtain the corresponding touch input based on the default dialog box N41, where the touch input is a clicking operation performed on a virtual button B41. Subsequently, the computer device 130 can generate the automated control command cmd to be provided to the electronic device under test 110 or the external execution device 140 based on the clicking operation performed on the virtual button B41. In other words, when the default dialog box N41 appears on the game screen of the electronic device under test 110, the computer device 130 can issue the automated control command cmd to click the virtual button B41, so as to control the electronic device under test 110 to execute subsequent target operations, such as displaying the next default dialog box or closing the current default dialog box N41.

Please refer to FIG. 5, which is a flowchart of determining an automated control command according to an embodiment of the disclosure. In step S510, during the process of executing a game application by the electronic device under test 110, the computer device 130 inputs the display image displayed by the electronic device under test 110 into a convolutional neural network (CNN) model. In some embodiments, the CNN model includes an image classification model or an object recognition model.

In step S520, the computer device 130 determines a touch input according to a model determination result of the CNN model. In some embodiments, the CNN model can be established through applying recorded game videos as training data. The recorded game videos can be obtained by screen recording when a player manually plays the game. The model determination result of the CNN model can be an image classification result or an object recognition result.

In some embodiments, the computer device 130 determines a target behavior of a virtual game character according to the model determination result of the CNN model. The target behavior of the virtual game character can include behaviors such as moving, attacking, jumping, or interacting. The computer device 130 determines the touch input based on the target behavior of the virtual game character and a game operation interface of the game application. For instance, when the computer device 130 determines that the target behavior of the virtual game character corresponds to a forward movement, the computer device 130 can ascertain that the touch input is located at the position of the user interface element that controls the movement of the virtual game character according to the game operation interface of the game application.

In step S530, the computer device 130 generates the automated control command according to the touch input. In some embodiments, the computer device 130 converts the touch input into a virtual touch command to be provided to the electronic device under test 110. In some embodiments, the computer device 130 converts the touch input into an action control command provided to the external execution device 140.

Please refer to FIG. 6, which is a schematic diagram of determining an automated control command according to an embodiment of the disclosure. In an operation 610, the computer device 130 inputs a display image IMG61 displayed by the electronic device under test 110 into an object detection model, and the object detection model can recognize a target object Obj1 in the display image IMG61. The object detection model can be, for instance, a YOLO model, a faster R-CNN model, an SSD model, or another object detection model, which should not be construed as a limitation in the disclosure. In other words, the object detection model is trained to identify specific objects in the game screen.

In an operation 620, the computer device 130 determines a target behavior B61 of the virtual game character according to the target object Obj1. In some embodiments, the computer device 130 determines an action type of the target behavior B61 according to the target object Obj1. The computer device 130 obtains the action type of the target behavior B61 by performing a table lookup based on the target object Obj1. In other words, different target objects can correspond to different target operations. After determining the action type of the target behavior B61, the computer device 130 can further obtain additional behavioral parameters of the target behavior B61, such as movement directions, based on other image features in the display image IMG61. For instance, the computer device 130 can further obtain the movement direction of the target behavior B61 based on a movable road range of the virtual game character and the target object Obj1 in the display image IMG61.

In an operation 630, the computer device 130 can determine a touch input T61 according to the target behavior B61 of the virtual game character and the game operation interface. In an operation 640, the computer device 130 can convert the touch input T61 into an automated control command cmd provided to the electronic device under test 110.

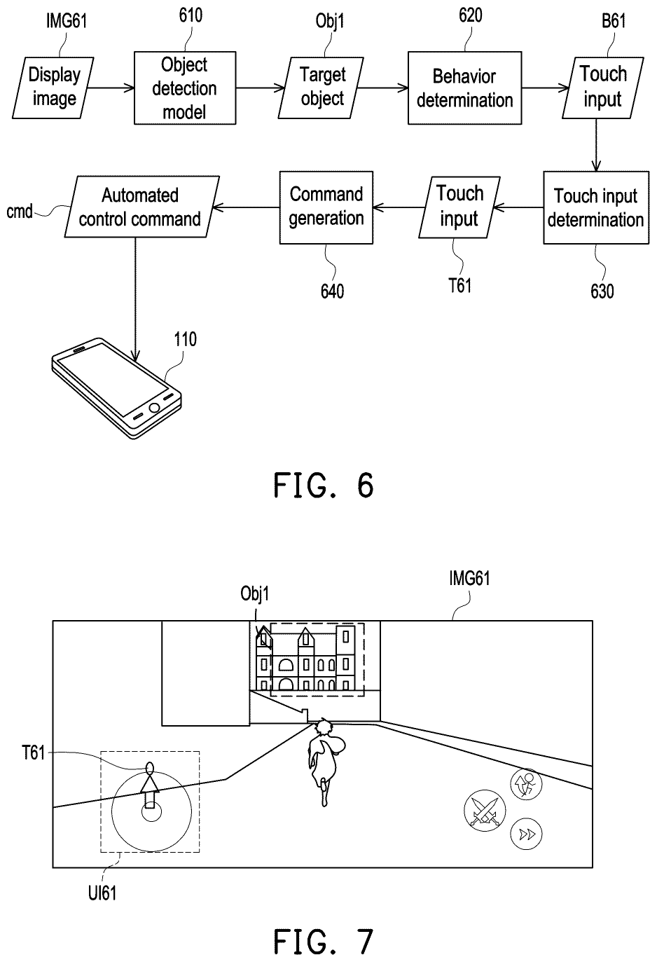

For instance, with reference to FIG. 7, the computer device 130 can use the object detection model to recognize the target object Obj1, e.g., a building, in the display image IMG61. The computer device 130 can determine the target behavior of the virtual game character as “tracking” based on the target object Obj1 according to predetermined rules. Subsequently, the computer device 130 can determine the movement direction of the target behavior “tracking” according to road information and the position of the target object Obj1 in the display image IMG61. Based on a movement control element UI61 in the game operation interface, the computer device 130 can determine the touch input T61 applied to the movement control element UI61 according to the target behavior “tracking” and its movement direction. After that, the computer device 130 can generate an automated control command according to the touch input T61. When the electronic device under test 110 receives this automated control command, the electronic device under test 110 can control the virtual game character to move forward towards the target object Obj1. Since an image sampling speed of the camera device 120 and a processing speed of the computer device 130 are greater than a movement and change speed of the virtual game character in the game, it can be guaranteed that the virtual game character can correctly track and move towards the target object and perform motion corrections of the virtual game character according to the changes in the display image.

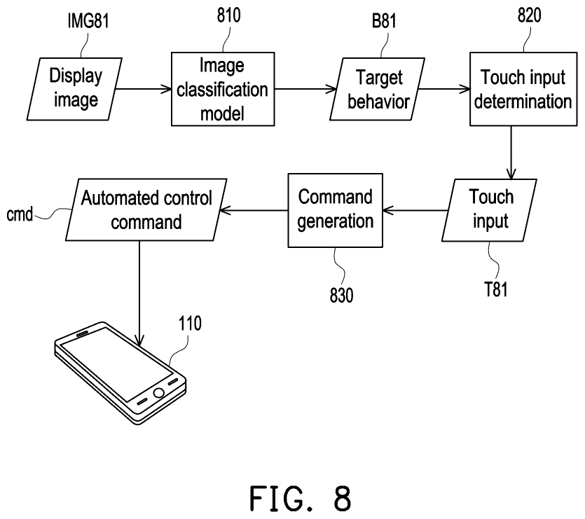

Please refer to FIG. 8, which is a schematic diagram of determining an automated control command according to an embodiment of the disclosure. In an operation 810, the computer device 130 inputs a display image IMG81 displayed by the electronic device under test 110 into an image classification model. The image classification model can classify the display image IMG81 into one of a plurality of predetermined categories to obtain a target behavior B81 corresponding to one of the predetermined categories. These predetermined categories correspond to different predetermined behaviors, respectively. The target behavior B81 is one of these predetermined behaviors. For instance, these predetermined behaviors can include forward movement, leftward movement, rightward movement, and so on.

In some other embodiments, in addition to inputting the display image IMG81 into the image classification model, the computer device 130 can further input the display image displayed by the electronic device under test 110 into an object detection model to obtain a target object in the display image IMG81. Accordingly, the computer device 130 can determine the target behavior of the virtual game character according to a classification result of the image classification model and the object recognition result of the object detection model.

Subsequently, in an operation 820, the computer device 130 can determine the touch input T81 according to the target behavior B81 of the virtual game character and the game operation interface. In an operation 830, the computer device 130 can convert the touch input T61 into an automated control command cmd provided to the electronic device under test 110.

To sum up, in one or more embodiments of the disclosure, the camera device can provide the display image displayed by the electronic device to the computer device for analysis. The computer device can analyze the real-time display image to determine the automated control command. The computer device can control the electronic device under test to execute the target operation corresponding to the automated control command. The electronic device under test can execute the device testing procedure during the execution of the target operation. By utilizing the computing resources of the computer device for visual analysis and issuance of the control command, the device testing procedure can be performed without occupying the computing resources of the electronic device under test. Accordingly, the power consumption and the collection of performance data by the automated test can be more accurate, and the manpower requirements for device testing can be effectively reduced.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic device testing method, comprising:
capturing a display image displayed by an electronic device under test through a camera device;
determining an automated control command by analyzing the display image displayed by the electronic device under test;
sending the automated control command to the electronic device under test or an external execution device to control the electronic device under test to execute a target operation corresponding to the automated control command; and
executing a device testing procedure of the electronic device under test during the execution of the target operation by the electronic device under test.

2. The electronic device testing method according to claim 1, wherein the automated control command comprises a virtual touch command sent to the electronic device under test.

3. The electronic device testing method according to claim 1, wherein the automated control command comprises an action control command sent to the external execution device, and the external execution device performs a touch operation on the electronic device under test according to the action control command.

4. The electronic device testing method according to claim 1, wherein the step of executing the device testing procedure of the electronic device under test during the execution of the target operation by the electronic device under test comprises:
executing a performance testing procedure of the electronic device under test during the execution of the target operation by the electronic device under test; and
obtaining a performance testing result of the performance testing procedure.

5. The electronic device testing method according to claim 1, wherein the display image comprises a game screen of a game application, and the step of sending the automated control command to the electronic device under test or the external execution device to control the electronic device under test to execute the target operation corresponding to the automated control command comprises:
executing the target operation corresponding to the automated control command by the game application of the electronic device under test.

6. The electronic device testing method according to claim 5, wherein the target operation comprises behavior control of a virtual game character.

7. The electronic device testing method according to claim 5, wherein the step of determining the automated control command by analyzing the display image displayed by the electronic device under test comprises:
comparing the display image with a plurality of default images; and
obtaining the automated control command corresponding to the one of the default images when the display image matches one of the default images.

8. The electronic device testing method according to claim 5, wherein the step of determining the automated control command by analyzing the display image displayed by the electronic device under test comprises:
inputting the display image into a convolutional neural network model; and
determining a touch input according to a model determination result of the convolutional neural network model; and
generating the automated control command according to the touch input.

9. The electronic device testing method according to claim 8, wherein the step of determining the touch input according to the model determination result of the convolutional neural network model and obtaining the automated control command corresponding to the touch input comprises:
obtaining a target behavior of a virtual game character according to the model determination result of the convolutional neural network model; and
determining the touch input according to the target behavior of the virtual game character and a game operation interface of the game application.

10. The electronic device testing method according to claim 8, wherein the convolutional neural network model comprises an image classification model or an object recognition model.

11. An electronic device testing system, comprising:
an electronic device under test;
a camera device, configured to capture a display image displayed by the electronic device under test; and
a computer device, coupled to the camera device,
wherein the computer device determines an automated control command by analyzing the display image displayed by the electronic device under test,
the computer device sends the automated control command to control the electronic device under test to execute a target operation corresponding to the automated control command, and
during the execution of the target operation by the electronic device under test, the electronic device under test executes a device testing procedure of the electronic device under test.

12. The electronic device testing system according to claim 11, wherein the computer device is coupled to the electronic device under test and sends the automated control command to the electronic device under test.

13. The electronic device testing system according to claim 11, further comprising an external execution device coupled to the computer device, wherein the computer device sends the automated control command to the external execution device, the automated control command comprises an action control command sent to the external execution device, and the external execution device performs a touch operation on the electronic device under test according to the action control command.
